(19) United States
(12) Patent Application Publication
(10) Pub. No.: US 2013/0076733 A1
(43) Pub. Date: Mar. 28, 2013

(54) IMAGE PROCESSING APPARATUS, IMAGE PROCESSING METHOD, AND IMAGE PROCESSING PROGRAM

(71) Applicants: Toshiyuki ONO, Kanagawa-ken (JP); Yasunori Taguchi, Kanagawa-ken (JP); Masahiro Sekine, Tokyo (JP); Nobuyuki Matsumoto, Tokyo (JP)

(72) Inventors: Toshiyuki ONO, Kanagawa-ken (JP); Yasunori Taguchi, Kanagawa-ken (JP); Masahiro Sekine, Tokyo (JP); Nobuyuki Matsumoto, Tokyo (JP)

(21) Appl. No.: 13/419,811

(22) Filed: Mar. 14, 2012

(30) Foreign Application Priority Data
Sep. 22, 2011 (JP) P2011-207822

(51) Int. Cl. G06T 15/00

(52) U.S. Cl. 345/419

(57) ABSTRACT

An image processing apparatus includes an acquiring unit, an area acquiring unit, a separating unit, a processing unit, and a synthesizing unit. The acquiring unit acquires a depth value of an object in an input image. The area acquiring unit acquires boundary coordinates of the object. The separating unit separates the input image into a first component as a component with gradation of the object and a second component as a component other than the first component. The processing unit converts the first component in accordance with the depth value to generate a processed component. The synthesizing unit synthesizes the processed component and the second component to generate a synthesized component.

### CROSS-REFERENCE TO RELATED APPLICATIONS

This application is based upon and claims the benefit of priority from the prior Japanese Patent Application No. 2011-207822, filed on Sep. 22, 2011, the entire contents of which are incorporated herein by reference.

### FIELD

Embodiments described herein generally relate to an image processing apparatus, an image processing method, and an image processing program.

### BACKGROUND

In a case where a distance from an image pickup device such as a camera to a subject is acquired, two images are created by applying binocular parallax thereto according to the distance and a user observes the two images through the right and left eyes, so that the image can be seen in three dimensions. However, in order to realize this system, for example, a display needs to be provided to display a video in a division manner based on time or space for the left and right eyes. In addition, the user should put on glasses, so that the configuration becomes complicated. Therefore, if a video is able to be displayed by increasing a stereoscopic effect with respect to the original two-dimensional video, such a configuration may be a great benefit for the user.

By emphasizing a subject with shading portions, uneven feeling is increased and the stereoscopic effect of the image is effectively increased. Herein, the uneven feeling is expressive power for unevenness on the surface of the subject. As a method of emphasizing the shading, a method of emphasizing gradation representing the uneven feeling with respect to the surface of the subject has been known. In the method, the gradient of an image is calculated, and then a component with a small magnitude of gradient is emphasized.

However, according to the method, since the entire image is emphasized uniformly, for example, the background arranged at a long distance is also increased in uneven feeling. The subject with the increased uneven feeling is perceived closer than before the processing. Therefore, in a case where a subject is present in the foreground, the foreground and the background are perceived closer to each other, and as a result the image becomes a flat composition which is poor in depth feeling. Herein, the depth feeling is expressive power for a distance between subjects in a depth direction.

### BRIEF DESCRIPTION OF THE DRAWINGS

FIG. 1 is a block diagram illustrating an image processing apparatus according to a first embodiment;

FIG. 2 is a diagram illustrating a hardware configuration of the image processing apparatus according to the first embodiment;

FIG. 3 is a flowchart illustrating the image processing apparatus according to the first embodiment;

FIG. 4 is a block diagram illustrating a separating unit according to the first embodiment;

FIG. 5 is a flowchart illustrating the separating unit according to the first embodiment;

FIG. 6 is a diagram illustrating an example of the object boundary coordinates according to the first embodiment;

FIG. 7 is a diagram illustrating an image area according to the first embodiment;

FIG. 8 is a diagram illustrating an example of a structure image and a separation image according to the first embodiment;

FIG. 9 is a diagram illustrating an example of the structure image and the separation image;

FIG. 10 is a diagram illustrating an example of the structure image and the separation image according to the first embodiment;

FIG. 11 is a diagram illustrating an example of the structure image and the separation image according to the first embodiment;

FIG. 12 is a block diagram illustrating an image processing apparatus according to Modification 1; and

FIG. 13 is a block diagram illustrating an image processing apparatus according to a second embodiment.

### DETAILED DESCRIPTION

In view of the above circumstances, an aspect of embodiments provides an image processing apparatus includes an acquiring unit, an area acquiring unit, a separating unit, a processing unit, and a synthesizing unit. The acquiring unit acquires a depth value of an object in an input image. The area acquiring unit acquires boundary coordinates of the object. The separating unit separates the input image into a first component as a component with gradation of the object and a second component as a component other than the first component. The processing unit converts the first component in accordance with the depth value to generate a processed component. The synthesizing unit synthesizes the processed component and the second component to generate a synthesized component.

According to the aspects of embodiments, it can be provided that an image processing apparatus which generates an image having expressive power of a distance between subjects in a depth direction.

Herein below, embodiments of the invention will be described with reference to the drawings.

(First Embodiment)

An image processing apparatus according to this embodiment is an apparatus which processes an input image to generate an image with an increased stereoscopic effect. For example, the image with an increased stereoscopic effect may be provided to a user by displaying an output image of the image processing apparatus in a television set.

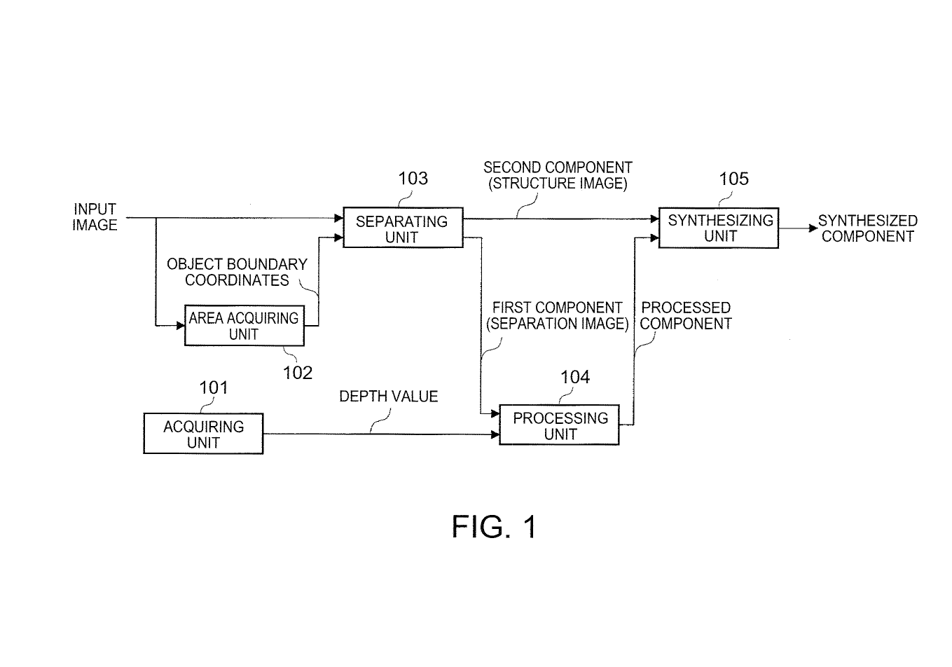

FIG. 1 is a block diagram illustrating an image processing apparatus according to a first embodiment. The image processing apparatus according to this embodiment includes an acquiring unit 101 that acquires a depth value of a subject in an input image, an area acquiring unit 102 that acquires boundaries of one or plural objects from the subject in the input image, a separating unit 103 that separates the input image into a first component as a component with gradation of the object and a second component as a component other than the first component, a processing unit 104 that converts the first component in accordance with the depth value to generate a processed component, and a synthesizing unit 105 that synthesizes the processed component and the second component to generate a synthesized component.

The input image can be acquired by imaging a subject using an image pickup device such as a camera. The object is an area which has the same brightness and color when the subject in the input image is illuminated under uniform light, for example. The subject in the input image includes one or plural objects.

Herein, the image processing apparatus according to this embodiment emphasizes the first component including gradation in accordance with the depth value of the subject. Specifically, an emphasis degree of the first component is increased as the subject comes to be closer to the front side (the depth value of the subject increases). Therefore, the image processing apparatus according to this embodiment can generate an image with an increased expressive power in accordance with a distance between subjects in a depth direction.

In addition, the image processing apparatus according to this embodiment generates an image at coordinates where the first component is emphasized by the processing unit 104 such that a component other than the gradation of the input image has the same value as a component other than the gradation of the synthesized component. Here, the component other than the gradation means a component representing another effect except the uneven feeling in the surface of a subject, for example, brightness of the subject in the input image. The image processing apparatus according to this embodiment suppresses variation of the component other than the gradation at coordinates where the gradation representing the uneven feeling is emphasized. Therefore, the image processing apparatus prevents the occurrence of an unnatural image, for example, an image in which only a part is brightened too much.

(Hardware Configuration)

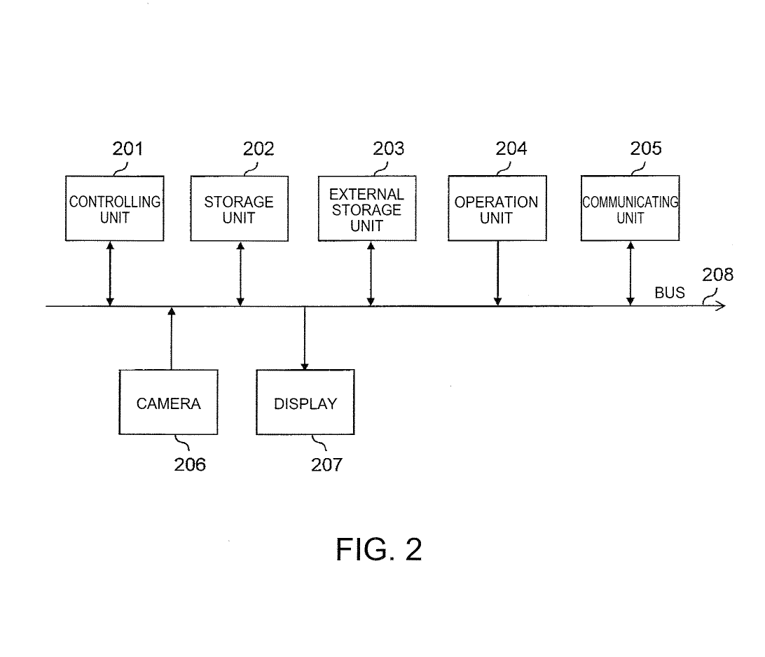

The image processing apparatus according to this embodiment is configured in hardware using a typical computer illustrated in FIG. 2, which includes a controlling unit 201 such as a central processing unit (CPU) which controls the entire apparatus, a storage unit 202 such as a read only memory (ROM) or a random access memory (RAM) which stores various kinds of data or various programs, an external storage unit 203 such as a hard disk drive (HDD) or a compact disk (CD) driver which stores various kinds of data or various programs, an operation unit 204 such as a keyboard or a mouse which receives instructions from a user, a communicating unit 205 which controls communication with an external device, a camera 206 which captures an image, a display 207 which displays an image, and a bus 208 through which the above components are connected to each other.

In such a hardware configuration, the controlling unit 201 realizes the functions to be described below by performing various programs stored in the storage unit 202 such as the ROM or the external storage unit 203.

(Flowchart)

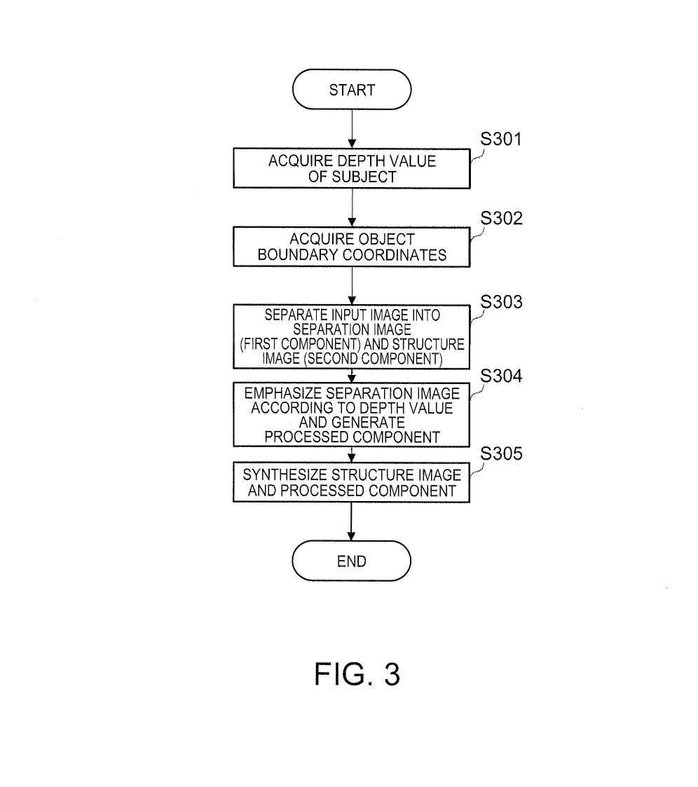

A process of the image processing apparatus according to this embodiment will be described with reference to a flowchart of FIG. 3.

First, in Step S301, the acquiring unit 101 acquires a depth value R of a subject in an input image. Herein, the depth value means, for example, a value corresponding to a distance from a predetermined lens of the camera 206 to a subject, which is acquired for each pixel of the input image. The depth value can be directly acquired using a distance sensor. In addition, using a stereoscopic image which is a combination of images captured through two lenses, the acquiring unit 101 can obtain a depth value in accordance with an amount of a positional deviation between the stereoscopic images. Specifically, the images for the right eye and an image for the left eye included in the contents of a stereoscopic vision can be used to acquire the depth value. In addition, the depth value may be estimated from one image using information on the degree of blur or contrast of the image.

In this embodiment, it is assumed that the depth value R(x, y) at coordinates (x, y) is a value ranging from 0 to 1, and as the value is larger, the image comes to be closer to the front side. Further, the range of the depth value is provided byway of example. Alternatively, as the value is smaller, the depth value representing a closer position to the front side may be used.

Next, in Step S302, the area acquiring unit 102 divides the input image for each object to acquire the coordinates of boundaries of each object (the object boundary coordinates). Herein, the object means an area having the same brightness and color when the subject is illuminated under uniform light. In an actual input image, the area of each object includes different brightness and colors under the influence of the way of illumination or the like. In this embodiment, assuming that the pixel values of an input image at the boundary between adjacent objects are distinct enough from each other, the coordinates having a large magnitude of gradient of the pixel value is acquired as the object boundary coordinates.

First, the magnitude of gradient of the input image is calculated for each of the coordinates. When the input image is denoted by Iᵢₙ, the magnitude of gradient Gᵢₙ can be calculated using Equation 1 below.

[Equation 1]

Gᵢₙ(x,y)={square root over ((Iᵢₙ(x,y)−Iᵢₙ(x−1,y))²+(Iᵢₙ(x,y)−Iᵢₙ(x,y−1))²)} (1)

In this case, (x, y) indicates an index representing the coordinates of the input image. For example, Iᵢₙ(x, y) represents a pixel value at the coordinates (x, y) of the input image Iᵢₙ. Further, when a color image is input, for example, among YUV components, the Y component (intensity) is processed as a pixel value and the UV components are processed according to the Y component.

Next, the magnitude of gradient for each of the coordinates is determined using a given threshold value. When it is determined that the magnitude of gradient is larger than the threshold value, the coordinates having the magnitude of gradient is acquired as the object boundary coordinates. In this embodiment, the object boundary coordinates are assumed to be in a form of an object boundary coordinates map M. Herein, it is assumed that in a case where M(x, y) is 1, the coordinates are the object boundary coordinates, and in a case of 0, the coordinates are not the object boundary coordinates.

Further, the way of taking the object into consideration is not limited to the above description. For example, every stuff in the real world may be considered as an object. In addition, an area of each object is generated through a clustering technique such as a mean shift technique, and the coordinates of the boundaries may be set as the object boundary coordinates.

Next, in Step S303, the separating unit 103 separates the input image into a structure image and a separation image. Herein, the structure image includes a portion of the input image with large magnitude of gradient such as an edge or the like. Meanwhile, the separation image includes a portion of the input image with small magnitude of gradient such as a gradation except the edge. In other words, the input image is separated by the separating unit 103 into the separation image (the first component) as a component with a gradation, and the structure image (the second component) as a component other than the first component.

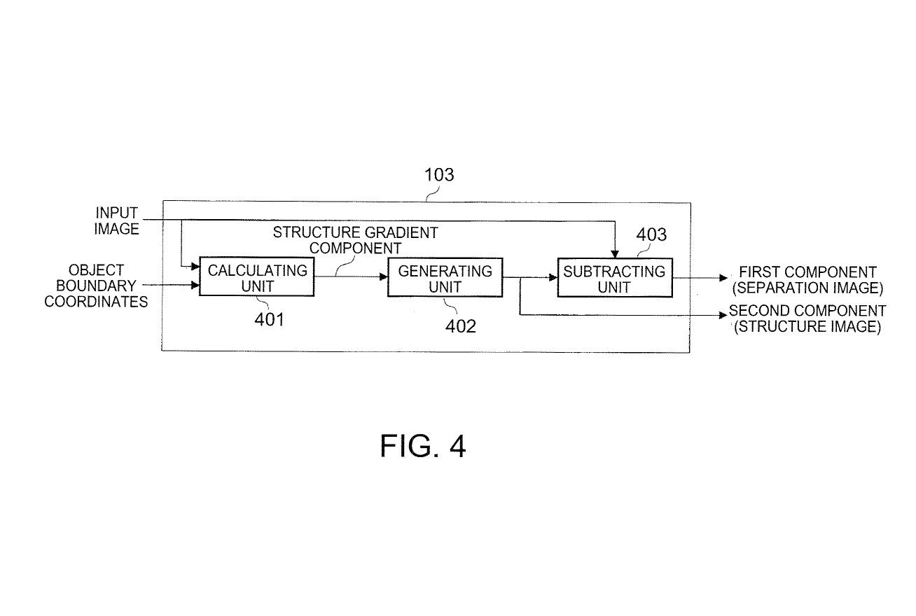

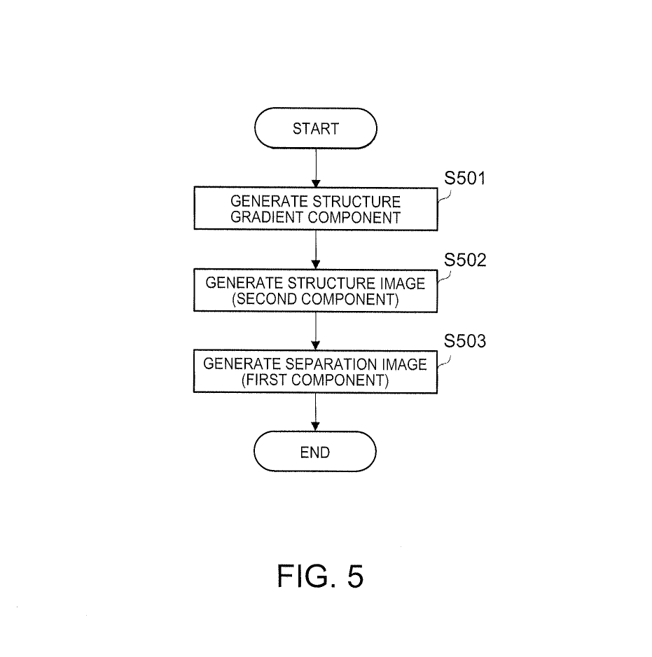

The operation of the separating unit 103 will be described with reference to FIGS. 4 and 5. FIG. 4 is a block diagram illustrating an internal configuration of the separating unit 103. The separating unit 103 includes a calculating unit 401 that generates a structure gradient component based on the input image and the object boundary coordinates map M, a generating unit 402 that generates the structure image based on the structure gradient component, and a subtracting unit 403 that generates the separation image based on the input image and the structure image.

FIG. 5 is a flowchart illustrating the operation of the separating unit 103. In Step S501, the calculating unit 401 generates the structure gradient component representing a gradient component of the structure image using the object boundary coordinates map M. First, a structure gradient component gₕₒᵣ in a horizontal direction is calculated. When M(a, b) is 0 at the coordinates (a, b) of interest, gₕₒᵣ(a, b) is set to 0. When M(a, b) is 1, the coordinates (c, d) within the closest position at which M (x, y) becomes 1 is obtained among the coordinates smaller than the coordinates (a, b) in the horizontal direction. Further, gₕₒᵣ is calculated by subtracting pixel values from each other between the coordinates as expressed by Equation 2.

[Equation 2]

gₕₒᵣ(a,b)=Iᵢₙ(a,b)−Iᵢₙ(c,d) (2)

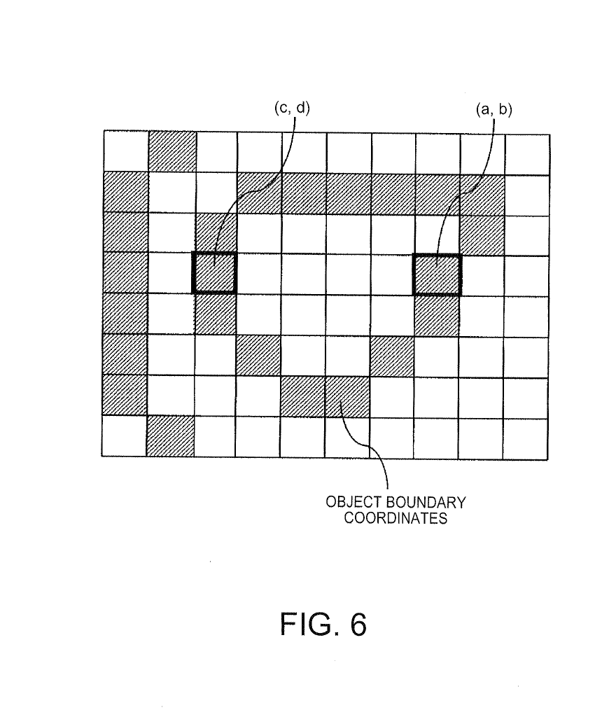

The relation between the coordinates (a, b) and the coordinates (c, d) will be described with reference to FIG. 6. FIG. 6 illustrates an example of the object boundary coordinates map M. A hatched frame in FIG. 6 represents the object boundary coordinates (M=1). Referring to the coordinates (a, b), a plurality of the object boundary coordinates are present in the horizontal direction. Among the coordinates, the coordinates which have a horizontal coordinate (located on the left side) smaller than that of the coordinates (a, b) and are nearest thereto are selected as the coordinates (c, d).

Similarly, a structure gradient component gᵥₑᵣ in a vertical direction is calculated. In other words, when M(a, b) is 0 at the coordinates (a, b) of interest, gᵥₑᵣ(a, b) is set to 0. When M(a, b) is 1, the coordinates (e, f) within the closest position at which M(x, y) becomes 1 is obtained among the coordinates smaller than the coordinates (a, b) in the vertical direction. Further, gᵥₑᵣ is calculated by performing the subtraction between pixel values of the input image located between the coordinates (using Equation 3).

[Equation 3]

gver(a,b)=Iᵢₙ(a,b)−Iᵢₙ(e,f) (3)

Next, in Step S502, the generating unit 402 generates a structure image Iₛₜ which includes the structure gradient component gₕₒᵣ in the horizontal direction and the structure gradient component gᵥₑᵣ in the vertical direction as a gradient component. As a method of generating an image having a predetermined gradient, there is widely known a solution by resolving a problem using Poisson's equation (for example, R. Fattal et al., “Gradient domain high dynamic range compression”, SIGGRAPH Conference, pp. 249-256, 2002).

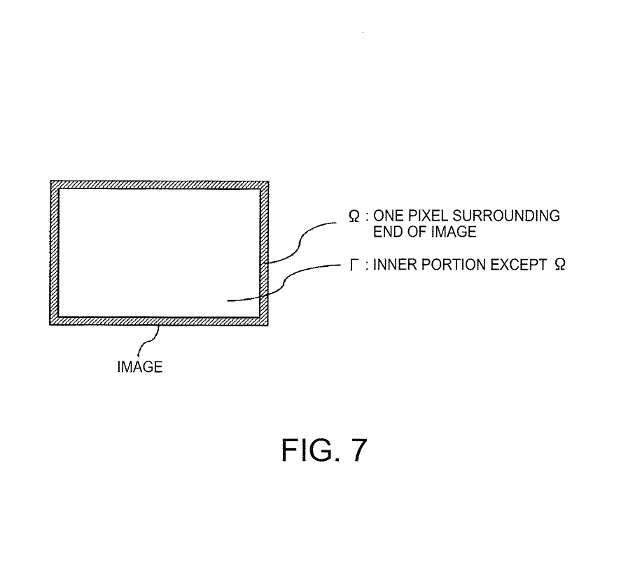

The generating unit 402 satisfies Equation 4 representing a boundary condition to hold a pixel value of the input image within an area Ω of one pixel surrounding the end of an image as illustrated in FIG. 7.

[Equation 4]

Iₛₜ(x,y)=Iᵢₙ(x,y) for ∀(x,y)εΩ (4)

Further, the generating unit 402 calculates an image (the structure image) Iₛₜ of which the gradient approaches the structure gradient component gₛₜ=(gₕₒᵣ, gᵥₑᵣ) using Equation 5 below.

$$\begin{matrix}[ Equation 5 ] & \\ {I}_{st} = {argmin}_{I} \int \int {‖ ∇ I - {g}_{st} ‖}^{2} d x d y & ( 5 )\end{matrix}$$

In this case, ∇I=(∂I/∂x, ∂l/∂y). By transforming Equation 5, Poisson's equation of Equation 6 below is concluded, which can be resolved through the Jacobi method, the Gauss-Seidel method, the SOR method, or the like.

[Equation 6]

∇²Iₛₜ=div gₛₜ (6)

In addition, the structure image Iₛₜ can be resolved by processing a sine transformed coefficient. For example, in a case of using the Jacobi method, Equation 7 below is iteratively resolved for the inner area (x, y)εΓ except the area Ω.

[Equation 7]

Iₛₜ^{N+1}(x,y)=¼(Iₛₜⁿ(x+1,y)+Iₛₜⁿ(x−1,y)+Iₛₜⁿ(x,y+1)+Iₛₜⁿ(x,y−1)−(div gₛₜ)(x,y)) (7)

In this case, Iₛₜⁿ represents a structure image with n iterations, and (div gₛₜ)(x, y) is calculated using Equation 8 below.

[Equation 8]

(div gₛₜ)(x,y)=gₕₒᵣ(x,y)−gₕₒᵣ(x−1,y)+gᵥₑᵣ(x,y)−gᵥₑᵣ(x,y−1) (8)

When n reaches a predetermined number or after the iteration is repeatedly performed until the variation of Iₛₜⁿ due to the iteration is sufficiently reduced, Iₛₜⁿ is set as the final structure image Iₛₜ.

Next, in Step S503, the subtracting unit 203 generates a separation image I_{gr} by subtracting the structure image Iₛₜ from the input image.

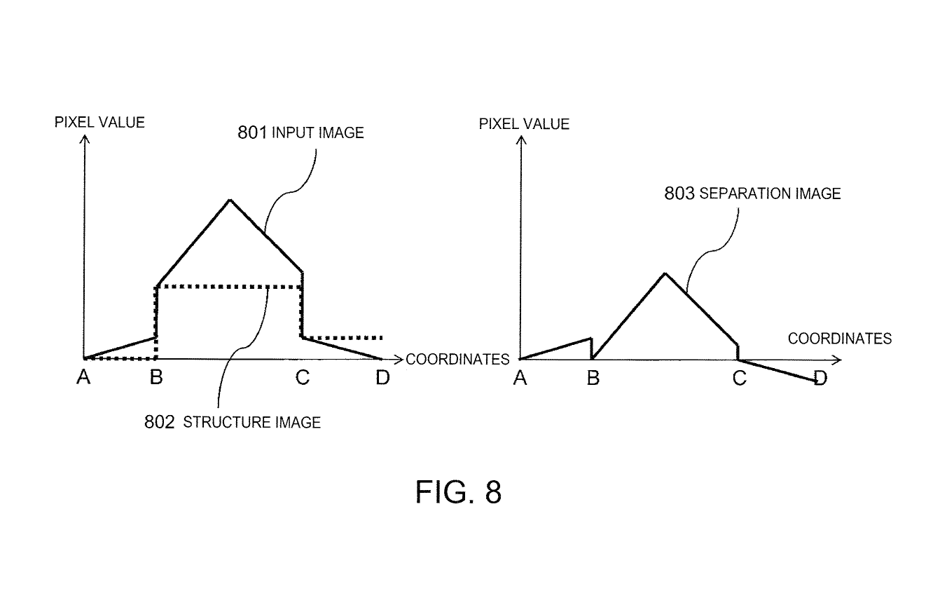

FIG. 8 is a diagram illustrating an example of the structure image and the separation image which have been separated from the input image. FIG. 8 illustrates a graph in which a pixel value at a given cross unit of the input image is one-dimensionally represented. In a case where the pixel value of the input image traces the form marked with 801, the pixel values of the structure image and the separation image generated by the separating unit 103 trace the forms marked with 802 and 803, respectively. Herein, A, B, C, and D represent the object boundary coordinates, and each of A-B, B-C, and C-D represents one object.

As illustrated in FIG. 8, the structure image is a component in which the pixel value at the edge portion of the input image mainly varies. The separation image is a component which includes mainly gradation or fine texture and represents a shaded portion. Herein, the separation image generated by the separating unit 103 according to this embodiment has at least one pixel value with zero in a pair of two closest object boundary coordinates. In other words, the pixel value of the separation image becomes zero at the coordinates A in the pair of coordinates A-B, B in the pair of coordinates B-C, and C in the pair of coordinates C-D.

As described above, it is important that the separation image is separated so as to be zero in at least one coordinates of the boundary of the object. With the use of the separation image, a component other than gradation can be suppressed from varying through an emphasizing operation of the processing unit 104 to be described later. The processed component also becomes zero at the coordinates where the separation image becomes zero. In other words, at the coordinates, a component other than the gradation of the input image and a component other than the gradation of the synthesized component are made to have the same value. Therefore, the occurrence of an unnatural image, for example, an image in which only a part is brightened too much can be prevented.

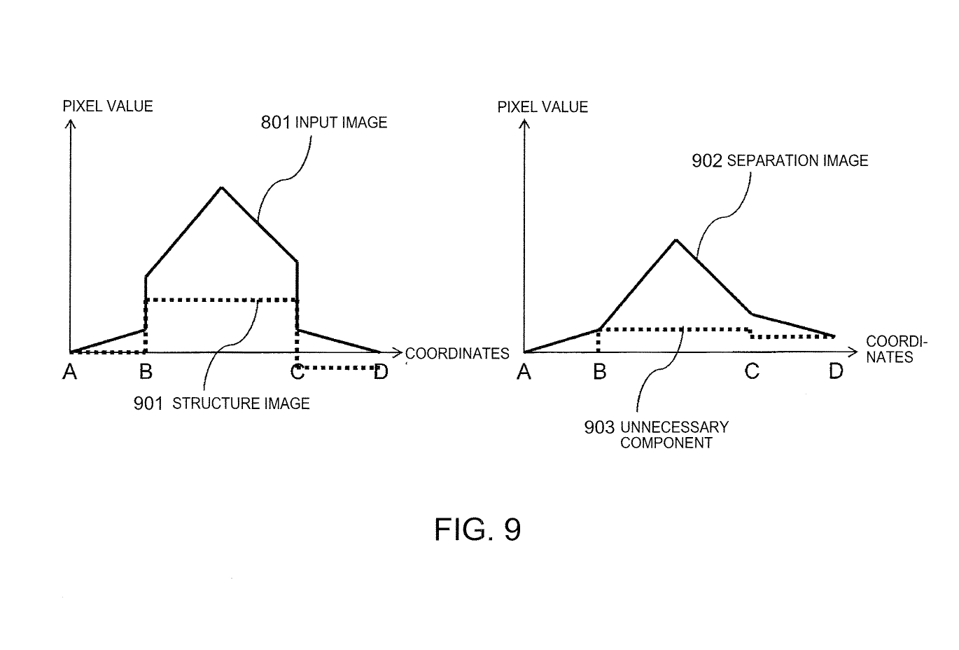

For example, in a case where the input image is separated as illustrated in FIG. 9, when the separation image is emphasized by the processing unit 104, an unnecessary portion 903 other than gradation is also emphasized. As a result, a component other than the gradation of the synthesized component varies, thereby generating an unnatural image, for example, an image in which only a part is brightened too much.

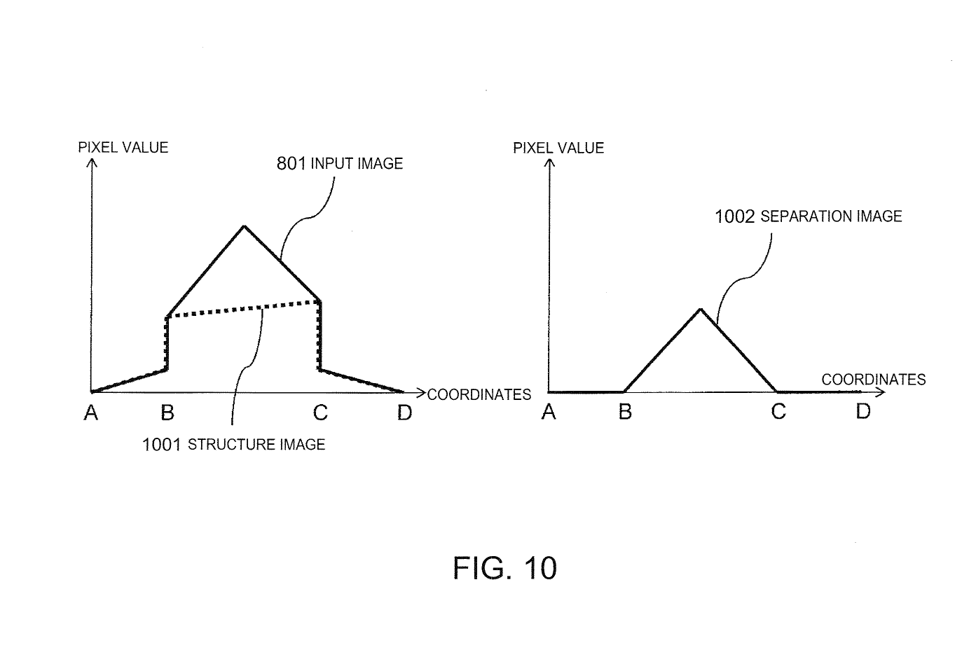

The method of separating the input image is not limited to the aforementioned methods. For example, as illustrated in FIG. 10, the pixel value at the object boundary coordinates of the structure image is made to be equal to that of the input image, and the pixel values at the coordinates except the object boundary coordinates can be generated by interpolating the pixel value at the object boundary coordinates.

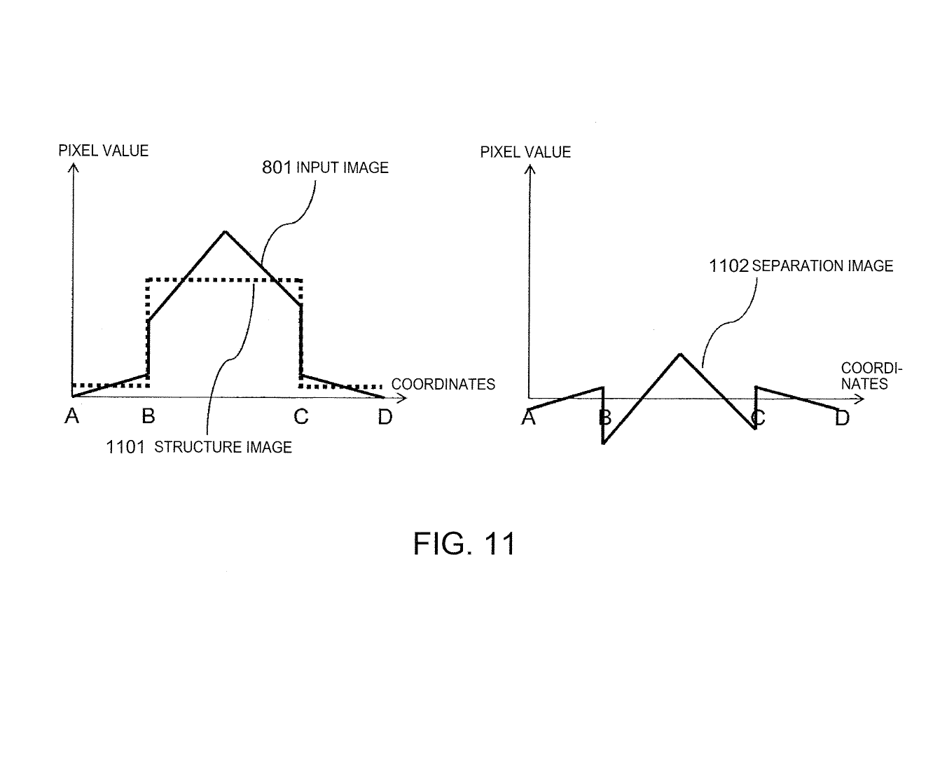

In addition, as illustrated in FIG. 11, the input image can be separated such that an average pixel value of the areas of the respective objects in the separation image becomes zero. For example, an average pixel value in the area of the object is calculated. It is assumed that the average pixel value represents the structure image of the areas of the respective objects and a pixel value obtained by subtracting the pixel value corresponding to the structure image from the pixel value of the input image represents the separation image.

Returning to the flowchart of FIG. 3, the description will continue. In Step S304, the processing unit 104 emphasizes the separation image according to the depth value so as to generate the processed component. In this embodiment, as the subject comes to be closer to the front side (as the depth value R of the subject increases), the emphasis degree becomes higher. Therefore, an image is generated such that the distance in the depth direction of a subject on the deeper side is perceived to be increased more than that of a subject on the front side. A subject with the enhanced uneven feeling through the emphasis of the separation image (the first component) is perceived to be closer to the front side.

With the use of the separation image I_{gr} and the depth value R, the processing unit 104 calculates the processed component Î_{gr} by Equation 9. Further, in Equation 9, the character I attached with the head symbol “̂” will be denoted by “Î” in the specification.

[Equation 9]

Î_{gr}(x,y)=I_{gr}(x,y)×α(R(x,y)) (9)

Herein, α(r) is a processing coefficient which takes a larger value as the depth value is of a subject closer to the front side. The processing coefficient α(r) can be expressed by Equation 10 with the use of a positive constant β.

[Equation 10]

α(r)=βr (10)

In addition, with the use of a positive constant ω, the processing coefficient α(r) may be expressed by Equation 11 in a nonlinear form.

[Equation 11]

α(r)=ωe^{-βr}^{²} (11)

As described above, the processing coefficient α can take a value of any positive value. In a case where the processing coefficient α is greater than 1, the separation image is emphasized, so that the shading portion of the processed component is displayed to be more dark. In addition, in a case where the processing coefficient α is smaller than 1, the separation image is suppressed, so that the shading portion of the processed component is displayed to be less dark. Furthermore, the emphasizing of the separation image is not limited to the multiplying of the processing coefficient α. For example, the emphasis effect may be achieved by adjusting the absolute value through the addition of the processing coefficient α as Equation 12 below.

[Equation 12]

Î_{gr}(x,y)=sign(I_{gr}(x,y))×(|I_{gr}(x,y)|+α(R(x,y))) (12)

Herein, the term sign(i) represents a positive or negative sign of i. Alternatively, a table may be previously created which is used to convert the value so as to increase according to the depth value R, so that the absolute value of the separation image can be converted according to the table.

In this case, the description has been made for the case where with a value representing the foremost object among the depth values as a reference value, as a difference between the reference value and the depth value increases, the separation image is emphasized. However, the reference value is not limited thereto. With the reference value set to the intermediate depth value or the largest depth value, as the depth value becomes close to the reference value, the separation image may be emphasized. For example, when a given intermediate depth value is set to r_{base}, α which increases as the depth value R(x, y) becomes close to r_{base} may be used in Equation 9. The value α can be calculated, for example, by Equation 13 with a positive constant ω.

[Equation 13]

α(r)=ωe^{-β(r-r}^{_{base}}⁾^{²} (13)

Therefore, in a case where only an object having a given depth value r_{base} is intensively illuminated, the object located at the depth can be emphasized.

Returning to the flowchart of FIG. 3, the description will continue. Finally, in Step S305, the synthesizing unit 105 synthesizes the structure image Iₛₜ and the processed component Î_{gr} to generate the synthesized component I_{comb}. The synthesizing unit 105 generates the synthesized component I_{comb}, for example, by Equation 14.

[Equation 14]

I_{comb}(x,y)=Iₛₜ(x,y)+Î_{gr}(x,y) (14)

The synthesized component I_{comb}, which is generated through the above process, becomes an image which is output by the image processing apparatus according to this embodiment.

As described above, the image processing apparatus according to this embodiment, as an object comes to be closer to the front side, the synthesized component in which the emphasis degree of the separation image (the first component) is increased is generated. With this configuration, it is possible to generate an image with an increased expressive power according to the distance between the objects in the depth direction.

In addition, the image processing apparatus according to this embodiment generates the synthesized component at the coordinates where the separation image (the first component) is emphasized such that a component other than the gradation of the input image has the same value as a component other than the gradation of the synthesized component. Therefore, the occurrence of an unnatural image, for example, an image in which only a part is brightened too much can be prevented.

(Modification 1)

With the use of a method according to this embodiment, the variation in the brightness of the separation component and the processed component can be reduced. However, when the variation of the processing coefficient α(r) becomes spatially large, the variation in the brightness may be increased before and after the processing. Therefore, the separation image may be separated from the input image such that an average value of the processed component is equal to an average value of the separation image in the area of each object.

For example, it is assumed that the pixel value of the structure image in the area of one object is set to a constant value J, and the separation image is obtained by Iᵢₙ−J. In this case, the processed component is obtained by α(R(x, y))×(Iᵢₙ−J), so that the value of J may be calculated to satisfy Equation 15. However, the integration is performed at the coordinates in one area. For example, the value of J can be changed into a discrete value.

[Equation 15]

∫(Iᵢₙ−J)×α(R(x,y))dxdy=∫(Iᵢₙ−J)dxdy (15)

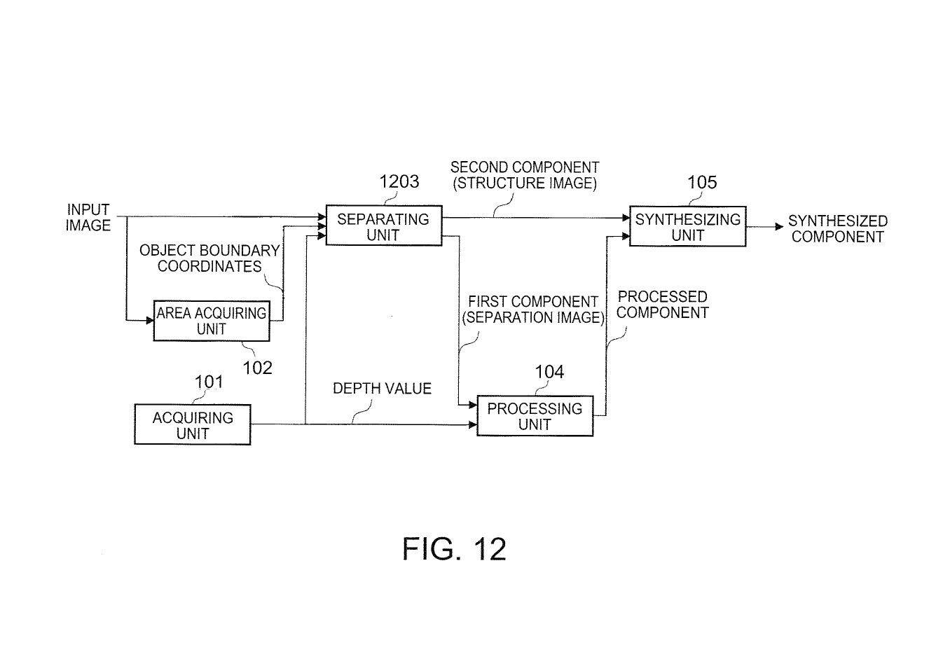

A method of realizing Modification 1 will be described with reference to FIG. 12. The image processing apparatus according to Modification 1, the separating unit 1203 is different from that of the first embodiment in that the depth value is input as well as the input image and the object boundary coordinates. First, the separating unit 1203 calculates the processing coefficient α using the same method as the processing unit 104. Then, the separating unit 1203 calculates the value of J which satisfies Equation 15 in an area of one object. For the area of the same object, the separating unit 1203 outputs the pixel value of the structure image as the value of J, and outputs the separation image as the value of Iᵢₙ−J. The same processing is performed with respect to the other objects.

As described above, by making the average value of the separation image equal to the average value of the processed component in the area of each object, it is prevented that the component other than the gradation varies significantly between the input image and the synthesized component. Therefore, the occurrence of an unnatural image, for example, an image in which only a part is brightened too much can be prevented.

(Second Embodiment)

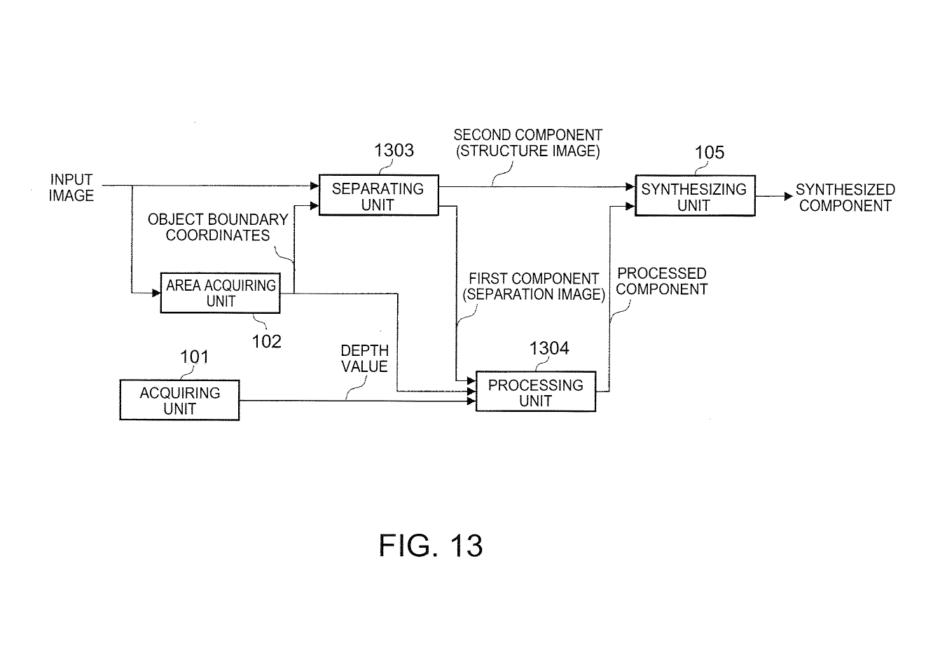

FIG. 13 is a block diagram illustrating an image processing apparatus according to a second embodiment. The image processing apparatus according to this embodiment is different from the first embodiment in the functions of the separating unit 1303 and the processing unit 1304. The other functions are equal to those of the image processing apparatus according to the first embodiment, and the description thereof will not be repeated.

The separating unit 1303 separates the input image into the structure image and the separation image. In this embodiment, when the input image is separated, there is no limitation between the structure image and the separation image. For example, as illustrated in FIG. 9, the input image may be separated such that the separation image includes an unnecessary component other than gradation.

The processing unit 1304 generates a processed component in which the separation image is emphasized using an object boundary coordinate map M and a depth value. At this time, the processing unit 1304 generates the processed component such that a component other than the gradation of the input image and a component other than the gradation of the synthesized component generated by the synthesizing unit 105 do not significantly vary. Specifically, the processed component is generated such that the average value of the components other than the gradation does not vary in the area of each object.

First, the processing unit 1304 calculates the temporary processed component I⁻_{gr} by Equation 16 below using the separation image I_{gr} and the depth value R. Further, in Equation 16, the character I attached with the symbol “-” will be denoted by “I⁻” in the specification.

[Equation 16]

Ī_{gr}(x,y)=I_{gr}(x,y)×α(R(x,y)) (16)

Herein, α described in the first embodiment can be used.

Next, the processing unit 1304 calculates an average value Iₐᵥₑ of the separation image I_{gr} and an average value I⁻ₐᵥₑ of the temporary processed component in the area of one object. Then, the processed component in the same area is calculated by Equation 17 below.

[Equation 17]

Î_{gr}(x,y)=Ī_{gr}(x,y)−(Īₐᵥₑ−Iₐᵥₑ) (17)

In all areas of the object, the processed components are calculated by Equation 17.

The processing unit 1304 may generate the processed component such that one pixel value among those at the object boundary coordinates of each object does not vary. For example, at the coordinates where the absolute value of the separation image is minimized, the processed component can be generated such that the pixel value does not vary before and after the processing. First, the processing unit 1304 selects an area of one object. Next, the processing unit 1304 retrieves coordinates at which the absolute value of the separation image is minimized among the object boundary coordinates. The retrieved coordinates is set to (g, h). Next, with the pixel value I_{gr}(g, h) of the separation image at the coordinates (g, h) as a reference value, the processed component at the object boundary coordinates of the selected object is calculated by Equation 18 below.

[Equation 18]

Î_{gr}(x,y)=(I_{gr}(x,y)−I_{gr}(g,h))×α(R(x,y))+I_{gr}(g,h) (18)

For all areas of the object, the processed components are calculated by Equation 18.

With the use of the generated processed components in this way, the synthesizing unit 105 generates the synthesized component as an output of the image processing apparatus according to the second embodiment.

The image processing apparatus according to this embodiment, at the coordinates where the separation image (the first component) is emphasized, it is prevented that the difference between the component other than the gradation of the input image and the component other than the gradation of the synthesized component varies significantly. Therefore, the occurrence of an unnatural image, for example, an image in which only a part is brightened too much can be prevented.

(Modification 2)

In the first and second embodiments, the processing method has been described in which the variation of the average pixel value for each object is reduced. However, besides the method, the variation of an average radiance for each object on being displayed in the display may be processed so as to be reduced.

In addition, in the first and second embodiments, the processing of two-dimensional image has been described. A stereoscopic image including two parallax images for right and left eyes or a stereoscopic image including three or more parallax images may be subjected to the processing. Therefore, even in a case where a stereoscopic image is displayed in a three-dimensional display of an eyeglass system or a naked eye system, it is possible to display a three-dimensional image with enhanced three-dimensional appearance.

For example, the parallax images can be separately processed through the methods described in the first and second embodiments. In addition, by performing correlation between the processes of the parallax images, the image quality obtained after the processing is enhanced. For example, the area acquiring unit 102 can align the parallax images with respect to each other, and calculate the object boundary coordinates such that the areas at the corresponding coordinates belong to the same object. Therefore, the objects are separated with a high accuracy. In addition, the separation image or the processed component is provided in common to the parallax images, so that the variation between the output parallax images can be suppressed.

### Effect of the Embodiment

The image processing apparatus according to at least one of the above-described embodiments generates a synthesized component which has an increased emphasis degree of the separation image (the first component) as a subject comes to be closer to the front side. With this configuration, the image processing apparatus according can generate an image with an increased expressive power in accordance with a distance between subjects in a depth direction.

In addition, the image processing apparatus according to at least one of the embodiments can prevent that a component other than the gradation of the input image and a component other than the gradation of the synthesized component vary significantly. Therefore, the occurrence of an unnatural image, for example, an image in which only a part is brightened too much can be prevented.

Further, part or all of the functions in the above-described embodiments can be processed in software.

Embodiments of the invention have been described as an example. However, it is not intended that the scope of the invention is limited thereto. These novel embodiments can be implemented in various forms, and various omission, replacement, and changes can be made in the scope not departing from the gist of the invention. The embodiments and the modifications thereof are included in the scope and the gist of the invention, and also included in the claims and their equivalents.

What is claimed is:

1. An image processing apparatus comprising:
an acquiring unit configured to acquire a depth value of an object in an input image;
an area acquiring unit configured to acquire a boundary of the object;
a separating unit configured to separate the input image into a first component that is a component including gradation of the object and a second component that is a component other than the first component;
a processing unit configured to generate a processed component that is obtained by converting the first component according to the depth value; and
a synthesizing unit configured to generate a synthesized component that is obtained by synthesizing the processed component and the second component.

2. The apparatus according to claim 1,
wherein the synthesized component is generated at coordinates where the first component is converted by the processing unit such that a component other than the gradation of the input image has the same value as a component other than the gradation of the synthesized component.

3. The apparatus according to claim 2,
wherein the separating unit separates the input image into the first component and the second component to make the first component zero in at least one coordinates of the boundary of the object.

4. The apparatus according to claim 1,
wherein the processed component is generated such that an average value of the first components is equal to an average value of the processed component in an area of the object.

5. The apparatus according to claim 1,
wherein the separating unit separates the input image into the first component and the second component in an area of the object such that an average value of the first components becomes zero.

6. An image processing method comprising:
acquiring a depth value of an object in an input image;
acquiring a boundary of the object;
separating the input image into a first component that is a component including gradation of the object and a second component that is a component other than the first component;
generating a processed component that is obtained by converting the first component according to the depth value; and
generating a synthesized component that is obtained by synthesizing the processed component and the second component.

7. The method according to claim 6,
wherein the synthesized component is generated at coordinates where the first component is converted such that a component other than the gradation of the input image has the same value as a component other than the gradation of the synthesized component.

8. The method according to claim 7,
wherein the input image is separated into the first component and the second component to make the first component zero in at least one coordinates of the boundary of the object.

9. The method according to claim 6,
wherein the processed component is generated such that an average value of the first components is equal to an average value of the processed component in an area of the object.

10. The method according to claim 6,
wherein the input image is separated into the first component and the second component in an area of the object such that an average value of the first components becomes zero.

11. An image processing program causing an image processing apparatus to execute, stored in an information storage medium:
acquiring a depth value of an object in an input image;
acquiring a boundary of the object;
separating the input image into a first component that is a component including gradation of the object and a second component that is a component other than the first component;
generating a processed component that is obtained by converting the first component according to the depth value; and
generating a synthesized component that is obtained by synthesizing the processed component and the second component.

12. The program according to claim 11,
wherein the synthesized component is generated at coordinates where the first component is converted by the processing unit such that a component other than the gradation of the input image has the same value as a component other than the gradation of the synthesized component.

13. The program according to claim 12,
wherein the separating unit separates the input image into the first component and the second component to make the first component zero in at least one coordinates of the boundary of the object.

14. The program according to claim 11,
wherein the processed component is generated such that an average value of the first components is equal to an average value of the processed component in an area of the object.

15. The program according to claim 11,
wherein the separating unit separates the input image into the first component and the second component in an area of the object such that an average value of the first components becomes zero.
